(19) United States
(12) Patent Application Publication
(10) Pub. No.: US 2023/0230081 A1
(43) Pub. Date: Jul. 20, 2023

(54) ACCOUNT IDENTIFICATION METHOD, APPARATUS, ELECTRONIC DEVICE AND COMPUTER READABLE MEDIUM

(71) Applicant: BEIJING JINGDONG ZHENSHI INFORMATION TECHNOLOGY CO., LTD., Beijing (CN)

(72) Inventor: Ke ZHAO, Beijing (CN)

(73) Assignee: BEIJING JINGDONG ZHENSHI INFORMATION TECHNOLOGY CO., LTD., Beijing (CN)

(21) Appl. No.: 17/996,629

(22) PCT Filed: Mar. 15, 2021
(86) PCT No.: PCT/CN2021/080687

§ 371 Date: Oct. 20, 2022

(30) Foreign Application Priority Data
Apr. 23, 2020 (CN) 202010328202.4

(51) Int. Cl. G06Q 20/40; G06Q 20/22

(52) U.S. Cl. CPC G06Q 20/40; G06Q 20/227

(57) ABSTRACT

An account identification method, an apparatus, an electronic device, and a computer readable medium, pertaining to the technical field of the Internet. The method includes: obtaining various resource transfer records of which a resource pre-acquisition account is different from a resource receipt account; dividing the resource pre-acquisition account and the resource receipt account into multiple connected account sets; determining to-be-identified accounts in each of the connected account sets; obtaining sample accounts from the to-be-identified accounts, and training a target account identification model by using the sample accounts; and determining whether the to-be-identified accounts are a target account through the target account identification model.

### CROSS REFERENCE

The present disclosure is a U.S. national phase application of International Application No. PCT/CN2021/080687, filed on Mar. 15, 2021, which claims priority to Chinese Patent Application No. 202010328202.4, filed on Apr. 23, 2020 and entitled “ACCOUNT IDENTIFICATION METHOD, APPARATUS, ELECTRONIC DEVICE AND COMPUTER READABLE MEDIUM”, which are incorporated herein by reference in their entireties.

### TECHNICAL FIELD

The present disclosure relates to the field of Internet technology, in particular, to an account identification method, an account identification apparatus, an electronic device and a computer readable medium.

### BACKGROUND

Online shopping has become popular, when shopping in an online shopping platform, placing an order on another online shopping platform on behalf of a customer is often encountered, for example, provided in a shop of the online shopping platform. The shop of the online shopping platform may obtain coupons by some abnormal means, so as to attract customers from other platforms and to provide order placement services for the customer. The shop of the online shopping platform may also provide order placement services for customers who are accustomed to using other platforms, or may provide order placement services for consumers who do not know how to shop online.

Currently, there is no special risk control system to identify such a user crowd who provides the order placement services, which may lead to a series of after-sales problems and affect the user experience on the online shopping platform. However, the efficiency of manually identifying an account that provides the order placement services is very low. Therefore, an account identification method is needed to solve above problems and to improve the efficiency of identifying such accounts.

It should be noted that the information disclosed in above section is only for enhancement of understanding of the background of the present disclosure, and thus may contain information that does not form the prior art already known to those of ordinary skill in the art.

### SUMMARY

The purpose of the present disclosure is to provide an account identification method, an account identification apparatus, an electronic device, and a computer-readable medium.

According to one aspect of the present disclosure, an account identification method is provided, which includes:

obtaining, by an account processing server, resource transfer records of which a resource pre-acquisition account is different from a resource receipt account, and generating an account relationship data table according to the resource transfer records;

dividing the resource pre-acquisition account and the resource receipt account in the resource transfer records into a plurality of connected account sets according to the account relationship data table;

determining to-be-identified accounts in the plurality of connected account sets according to a connectivity relationship between accounts in each of the connected account sets, and sending the to-be-identified accounts to a model training server;

obtaining, by the model training server, sample accounts by sampling from the to-be-identified accounts, and training a target account identification model by using the sample accounts; and

determining whether the to-be-identified accounts are a target account through the target account identification model.

In some exemplary embodiments of the present disclosure, said obtaining, by an account processing server, resource transfer records of which a resource pre-acquisition account is different from a resource receipt account, and generating an account relationship data table according to the resource transfer records, includes:

obtaining, by the account processing server, account data of all resource transfer records, and determining whether the resource pre-acquisition account is the same as the resource receipt account in the account data of the resource transfer records;

removing account data of resource transfer records in response to the resource pre-acquisition account being the same as the resource receipt account in the resource transfer records; and

putting account data of resource transfer records into the account relationship data table in response to the resource pre-acquisition account being different from the resource receipt account in the resource transfer records.

In some exemplary embodiments of the present disclosure, said dividing the resource pre-acquisition account and the resource receipt account in the resource transfer records into a plurality of connected account sets according to the account relationship data table, includes:

obtaining the resource pre-acquisition account and the resource receipt account in the resource transfer records from the account relationship data table, and generating a plurality of account node relationship pairs by using the resource pre-acquisition account and the resource receipt account in the resource transfer records as account nodes;

obtaining an account node table by using one account node in each of the account node relationship pairs as a vertex, and the other account node as a connection point corresponding to the vertex;

putting a connection point corresponding to the same vertex in the account node table into the same set as an adjacency set corresponding to the vertex, and generating a node adjacency table according to adjacency sets corresponding to different vertexes;

generating a candidate node adjacency table according to the adjacency set in the node adjacency table, and determining whether the candidate node adjacency table is the same as the node adjacency table;

using, in response to the candidate node adjacency table being different from the node adjacency table, the candidate node adjacency table as the node adjacency table, and regenerating a candidate node adjacency table; and

obtaining, in response to the candidate node adjacency table being the same as the node adjacency table, the plurality of connected account sets according to the node adjacency table.

In some exemplary embodiments of the present disclosure, said generating a candidate node adjacency table according to adjacency sets corresponding to different vertexes in the node adjacency table, includes:

using each account node in each of the adjacency sets as a vertex, and an adjacency set where each account node is located as the adjacency set corresponding to the vertex; and

obtaining a candidate adjacency set by performing a union operation on the adjacency set corresponding to the same vertex, and generating the candidate node adjacency table according to candidate adjacency sets corresponding to different vertexes.

In some exemplary embodiments of the present disclosure, said determining to-be-identified accounts in the plurality of connected account sets according to a connectivity relationship between accounts in each of the connected account sets, includes:

obtaining number of resource transfers between each group of resource pre-acquisition account and resource receipt account in each of the connected account sets through the account relationship data table;

obtaining total number of accounts in each of the connected account sets and number of connected accounts having a receiving relationship with the resource pre-acquisition account in each of the connected account sets;

obtaining, according to the number of resource transfers, the number of connected accounts and the total number of accounts, closeness of the resource pre-acquisition account in each of the connected account sets; and

determining, according to the closeness of the resource pre-acquisition account, one to-be-identified account in each of the connected account sets.

In some exemplary embodiments of the present disclosure, said obtaining, by the model training server, sample accounts by sampling from the to-be-identified accounts, and training a target account identification model by using the sample accounts, includes:

sorting, by the model training server, the to-be-identified accounts according to the closeness, and dividing all to-be-identified accounts into a plurality of sets of the to-be-identified accounts according to a sorting result;

extracting a preset number of to-be-identified accounts from each of the sets of the to-be-identified accounts as the sample accounts, and determining whether the sample accounts are the target account;

adding a first label to sample accounts in response to the sample accounts being the target account, and adding a second label to remaining sample accounts among the sample accounts; and

obtaining account data indices of the sample accounts from the account relationship data table, and training the target account identification model using the account data indices of the sample accounts as an input and labels corresponding to the sample accounts as an output.

In some exemplary embodiments of the present disclosure, said training the target account identification model using the account data indices of the sample accounts as an input and labels corresponding to the sample accounts as an output, includes:

obtaining a plurality of model training data sets according to the account data indices of the sample accounts, and constructing the target account identification model through a random forest algorithm; and

training the target account identification model constructed through the random forest algorithm using the account data indices of the sample accounts as the input and the labels corresponding to the sample accounts as the output.

In some exemplary embodiments of the present disclosure, said determining whether the to-be-identified accounts are a target account through the target account identification model, includes:

obtaining account data indices of the to-be-identified accounts through the account relationship data table, and inputting the account data indices of the to-be-identified accounts into the target account identification model; and

determining the to-be-identified accounts as the target account in response to the output of the target account identification model being the first label.

According to another aspect of the present disclosure, an account identification apparatus is provided, which includes:

an account-relationship-data-table generation module configured to obtain, by an account processing server, resource transfer records of which a resource pre-acquisition account is different from a resource receipt account, and generate an account relationship data table according to the resource transfer records;

a connected-account-set division module configured to divide the resource pre-acquisition account and the resource receipt account in the resource transfer records into a plurality of connected account sets according to the account relationship data table;

a to-be-identified account determination module configured to determine to-be-identified accounts in the plurality of connected account sets according to a connectivity relationship between accounts in each of the connected account sets, and send the to-be-identified accounts to a model training server;

an account-identification-model training module configured to obtain, by the model training server, sample accounts by sampling from the to-be-identified accounts, and train a target account identification model by using the sample accounts; and

a target-account determination module configured to determine whether the to-be-identified accounts are a target account through the target account identification model.

According to another aspect of the present disclosure, an electronic device is provided, which includes: a processor; and a memory for storing instructions executable by the processor; wherein the processor is configured to execute the account identification method described in any of above aspects.

According to another aspect of the present disclosure, a computer-readable medium is provided, on which a computer program is stored, and when the computer program is executed by a processor, the account identification method described in any of above aspects is caused to be implemented.

It should be understood that the above general description and the following detailed description are only illustrative and explanatory, and do not limit the present disclosure.

### BRIEF DESCRIPTION OF THE DRAWINGS

The drawings, which are incorporated in and constitute a part of this specification, illustrate embodiments consistent with the present disclosure and serve together with the specification to explain principles of the present disclosure. It is apparent that the drawings in the following description are only some embodiments of the present disclosure, and for those of ordinary skill in the art, other drawings can also be obtained from these drawings without creative efforts.

FIG. 1 shows a schematic flowchart of an account identification method according to an exemplary embodiment of the present disclosure;

FIG. 2 shows a schematic flowchart of generating an account relationship data table according to an exemplary embodiment of the present disclosure;

FIG. 3 shows a schematic flowchart of determining a connected account set according to an exemplary embodiment of the present disclosure;

FIG. 4 shows a schematic diagram of acquiring a user relationship edge according to an exemplary embodiment of the present disclosure;

FIG. 5 shows a schematic diagram of acquiring a node adjacency table according to an exemplary embodiment of the present disclosure;

FIG. 6 shows a schematic flowchart of determining a candidate node adjacency table according to an exemplary embodiment of the present disclosure;

FIG. 7 shows a schematic diagram of acquiring a node class label according to an exemplary embodiment of the present disclosure;

FIG. 8 shows a schematic diagram of a union operation on distributed Disjoint Set of a node class label according to an exemplary embodiment of the present disclosure;

FIG. 9 shows a schematic flowchart of determining a to-be-identified account according to an exemplary embodiment of the present disclosure;

FIG. 10 shows a schematic flowchart of training a target account identification model according to an exemplary embodiment of the present disclosure;

FIG. 11 shows a schematic flowchart of training a target account identification model constructed through a random forest algorithm according to an exemplary embodiment of the present disclosure;

FIG. 12 shows a schematic flowchart of identifying a target account according to an exemplary embodiment of the present disclosure;

FIG. 13 shows a complete block diagram of an account identification method according to an exemplary embodiment of the present disclosure;

FIG. 14 shows a block diagram of an account identification apparatus according to an exemplary embodiment of the present disclosure; and

FIG. 15 shows a schematic structural diagram of a computer system of an electronic device suitable for implementing an exemplary embodiment of the present disclosure.

### DETAILED DESCRIPTION

Example embodiments will now be described more fully with reference to the drawings. Example embodiments, however, can be embodied in a variety of forms and should not be construed as being limited to examples set forth herein. Instead, these embodiments are provided so that the present disclosure will be thorough and complete, and will fully convey concepts of the example embodiments to those skilled in the art. The described features, structures or characteristics may be combined in any suitable manner in one or more embodiments. In the following description, many specific details are provided in order to give a thorough understanding of the embodiments of the present disclosure. However, those skilled in the art will recognize that technical solutions of the present disclosure can be practiced without one or more of particular details described, or other methods, components, devices, steps, etc. may be employed. In other cases, well-known solutions have not been shown or described in detail so as to avoid obscuring aspects of the present disclosure.

In addition, the drawings are merely schematic illustrations of the present disclosure and are not necessarily drawn to scale. The same reference numerals in the figures denote the same or similar parts, and thus their repeated description will be omitted. Some of the block diagrams shown in the drawings are functional entities and do not necessarily correspond to physically or logically separate entities. These functional entities may be implemented in software, or in one or more hardware modules or integrated circuits, or in different networks and/or processor devices and/or microcontroller devices.

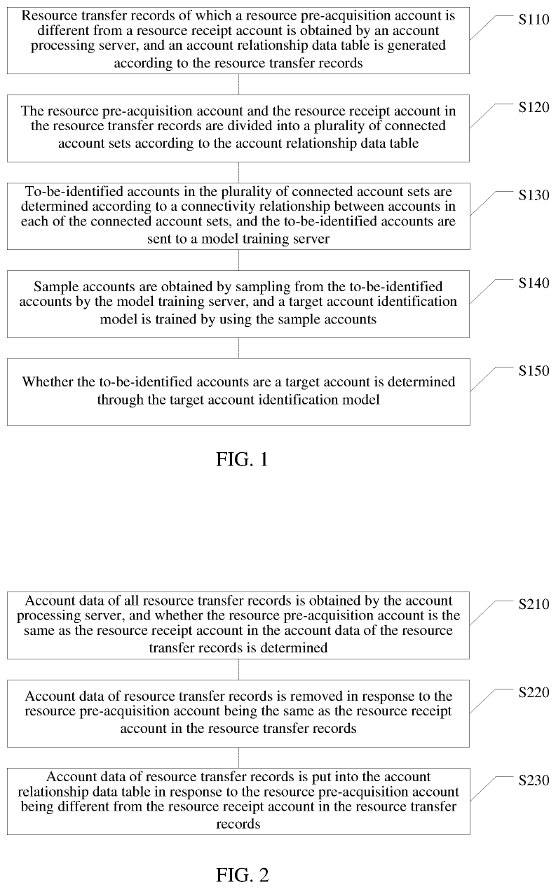

Example embodiments of the present disclosure first provide an account identification method, which can be used to identify among a plurality of accounts an account that provides order placement services. With reference to FIG. 1, the account identification method may include following steps.

In a step S110, resource transfer records of which a resource pre-acquisition account is different from a resource receipt account is obtained by an account processing server, and an account relationship data table is generated according to the resource transfer records.

In some example embodiments, the resource transfer records may refer to order records in a shopping process. Correspondingly, the resource pre-acquisition account may refer to an ordering account used by a user when placing an order, and the resource receipt account may refer to a receiving account used by the user when receiving a commodity.

The account processing server is a part of servers, which can be used to obtain order data from a terminal device and process the order data. The terminal device refers to an electronic device such as a smart phone, a computer, etc., through which the order for a commodity can be placed over a network.

The ordering account may refer to a mobile phone number used by a user who places an order for a commodity on an online shopping platform, or may include a login account and other accounts that can be used to determine the user who places the order. The receiving account may refer to a mobile phone number used by a user who receives the commodity corresponding to the order, or other accounts that can be used to determine the user who receives the commodity corresponding to the order.

In some examples, one order corresponds to one ordering account and one receiving account. The ordering account and the receiving account of the same order can be the same account or different accounts. Example embodiments of the present disclosure can be used to identify an account that provides order placement services. When order data is obtained, only order data of which the ordering account is different from the receiving account needs to be obtained, and an account relationship data table is generated according to such order data. The account relationship data table may include an order number, an ordering account, a receiving account, number of times of placing an order and other indicators of the order data.

In a step S120, the resource pre-acquisition account and the resource receipt account in the resource transfer records are divided into a plurality of connected account sets according to the account relationship data table.

In an undirected graph, if there is a path edge from a vertex u to a vertex v, then points u and v are referred to as be connected. If any pair of vertices in the undirected graph are connected, the graph is referred to as a connected graph. A user connected group refers to a group of users among which between any pair of users, one user provides order placement services to the other, that is, a connected account set.

The ordering account and the receiving account corresponding to each order are obtained through the account relationship data table, and the user accounts are divided into a plurality of connected account sets according to the relationship between the ordering account and the receiving account of the order. There are corresponding shopping relationships between accounts in each connected account set.

In a step S130, to-be-identified accounts in the plurality of connected account sets are determined according to a connectivity relationship between accounts in each of the connected account sets, and the to-be-identified accounts are sent to a model training server.

The connectivity relationship between accounts can be presented through closeness between an account and other accounts, and the to-be-identified accounts can be determined through the closeness between the to-be-identified accounts and other accounts. Determining the to-be-identified accounts in the connected account sets is to determine an account with the highest closeness in each of the connected account sets, that is, an account with the highest probability of providing order placement services.

After the to-be-identified accounts in each of the connected account sets are determined, the to-be-identified accounts are sent to the model training server. A target account identification model is trained in the model training server by using the to-be-identified accounts. The model training server is a part of servers, which can be used to process training data and train the target account identification model according to the training data.

In a step S140, sample accounts are obtained by sampling from the to-be-identified accounts by the model training server, and a target account identification model is trained by using the sample accounts.

After obtaining the to-be-identified accounts in each of the connected account sets, the model training server extracts a part of the to-be-identified accounts as sample accounts, and determines whether the sample accounts are target accounts. The target account identification model is trained according to account data indicators of the sample accounts obtained from the account relationship data table, and a determination result of whether the sample accounts are the target accounts. The target account identification model can be used to determine whether an account is a target account. When the target account is an account that provides order placement services, the target account identification model can be used for identification of the account that provides order placement services.

In a step S150, whether the to-be-identified accounts are a target account is determined through the target account identification model.

Account data indicators of the to-be-identified accounts are inputted into the trained target account identification model, and whether the to-be-identified accounts are the target account can be determined.

According to the account identification method provided by example embodiments of the present disclosure, a plurality of to-be-identified accounts can be determined according to the connectivity relationship between accounts, a target account identification model is trained through a part of sample accounts extracted from the to-be-identified accounts, and which account(s) among the plurality of to-be-identified accounts is(are) the target account is determined by using the target account identification model. According to the account identification method provided by example embodiments of the present disclosure, an account identification model can be trained by using sample accounts obtained through sampling, and the account identification model can be used to identify accounts in a plurality of resource transfer records, so as to determine the target account among the accounts, which improves the efficiency of account identification, and greatly reduces the workload of the staff. Therefore, by using above method provided by example embodiments of the present disclosure, accounts of orders can be identified, and an account(s) that provides order placement services among the accounts can be determined, so as to identify real consumer groups.

Steps in above example embodiments will be described in the following in more detail with reference to FIGS. 2 to 11.

As shown in FIG. 2, the step S110, in which resource transfer records of which a resource pre-acquisition account is different from a resource receipt account is obtained by an account processing server, and an account relationship data table is generated according to the resource transfer records, includes following steps.

In a step S210, account data of all resource transfer records is obtained by the account processing server, and whether the resource pre-acquisition account is the same as the resource receipt account in the account data of the resource transfer records is determined.

The account processing server can obtain the account data of all resource transfer records, that is, the account data of all orders, sent by the terminal device, and store the account data in a data storage module of the server, and then obtain the account data from the data storage module of the server for data processing. In some embodiments, the data storage module may contain an order number, a mobile phone number of a user who places the order, a mobile phone number of a user who receives a commodity, number of times of placing an order and other data information of the order. In some examples, the account data of orders within a month or a quarter can be obtained for analysis, which will not be specifically limited.

In a step S220, account data of resource transfer records is removed in response to the resource pre-acquisition account being the same as the resource receipt account in the resource transfer records.

When determining whether the resource pre-acquisition account is the same as the resource receipt account in the resource transfer records, it is to determine whether the ordering account is the same as the receiving account of an order. If the ordering account is the same as the receiving account of an order, a precondition for providing order placement services will not be met, then the account data corresponding to the order is deleted, so as to reduce the calculation workload.

In a step S230, account data of resource transfer records is put into the account relationship data table in response to the resource pre-acquisition account being different from the resource receipt account in the resource transfer records.

If the ordering account is different from the receiving account of an order, it indicates that the order may be an order that provides order placement services, then the account data corresponding to the order will be put into the account relationship data table.

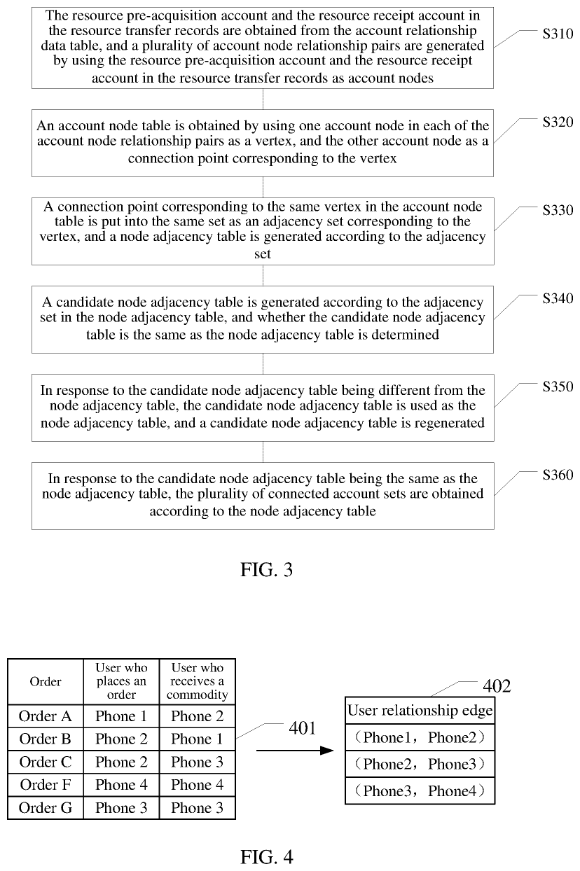

After the account relationship data table is generated, the accounts can be divided into a plurality of connected account sets according to the relationship between the ordering account and the receiving account corresponding to each order in the account relationship data table. A specific method will be described in combination with FIGS. 3 and 4.

As shown in FIG. 3, the step S120, in which the resource pre-acquisition account and the resource receipt account in the resource transfer records are divided into a plurality of connected account sets according to the account relationship data table, includes following steps.

In a step S310, the resource pre-acquisition account and the resource receipt account in the resource transfer records are obtained from the account relationship data table, and a plurality of account node relationship pairs are generated by using the resource pre-acquisition account and the resource receipt account in the resource transfer records as account nodes.

In example embodiments of the present disclosure, the accounts can be divided into a plurality of connected account sets by using a distributed Disjoint Set method. The plurality of connected account sets can also be obtained by using other methods, which will not be specifically limited by example embodiments of the present disclosure. The distributed Disjoint Set method is only taken as an example for explanation.

The distributed Disjoint Set method is a method of obtaining a connected graph by merging a pair of nodes with a connected relationship. In example embodiments of the present disclosure, the distributed Disjoint Set method is to use the MapReduce (mapping and reduction) distributed operation to assign labels to account nodes having connected relationship by using a label function, and then iteratively perform blocking and merging operation on class label data of nodes according to a determination condition until the class label of each node no longer changes.

The account nodes are divided into a plurality of connected account sets by using the distributed Disjoint Set method. First, account node relationship pairs are needed to be obtained based on the account relationship data table, and the account node relationship pairs are sorted in order. For example, the account with a small mobile phone number can be sorted in the front for process. As shown in FIG. 4, an order user table 401 is obtained from the account relationship data table. The order user table 401 includes accounts of a user who places an order and a user who receives a commodity, corresponding to each order. Since the user who places an order and the user who receives a commodity of an order G are the same, data of the order G is deleted and will not be considered. After the order user table 401 is obtained, a plurality of account node relationship pairs are generated, according to the accounts of the user who places an order and the user who receives a commodity corresponding to each order in the table. That is, a user-relationship edge table 402 in FIG. 4 is generated, and the account node relationship pairs in the table are sorted according to the mobile phone number.

In a step S320, an account node table is obtained by using one account node in each of the account node relationship pairs as a vertex, and the other account node as a connection point corresponding to the vertex.

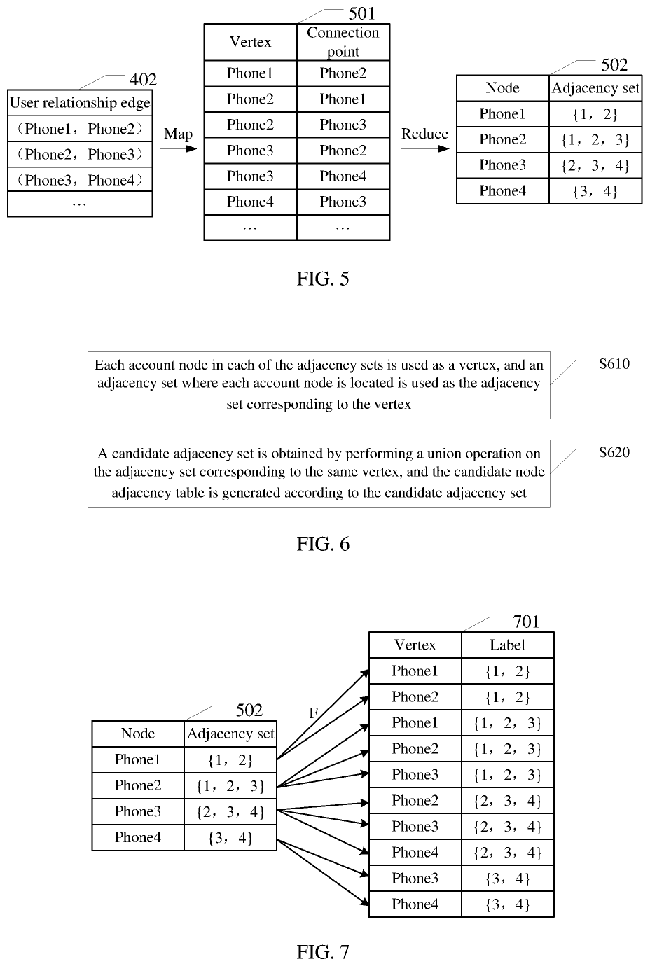

One account node in an account node relationship pair is used as a vertex, and the other account node in the account node relationship pair is used as a connection point corresponding to the vertex. An account node table is obtained by spreading the vertex and the connection point in sequence, as shown in the account node table 501 in FIG. 5.

In a step S330, a connection point corresponding to the same vertex in the account node table is put into the same set as an adjacency set corresponding to the vertex, and a node adjacency table is generated according to adjacency sets corresponding to different vertexes.

As shown in FIG. 5, the node adjacency table 502 is obtained according to the account node table 501. The connection point corresponding to the same vertex in the account node table 501 and the vertex itself are put into the same set as the adjacency set corresponding to the vertex. For example, the connection points corresponding to a mobile phone 2 include a mobile phone 1 and a mobile phone 3, then the vertex “mobile phone 2” and the connection points “mobile phone 1” and “mobile phone 3” are put into the adjacency set corresponding to mobile phone 2. The adjacency set corresponding to mobile phone 2 is {1, 2, 3}, and so on.

In a step S340, a candidate node adjacency table is generated according to the adjacency set in the node adjacency table, and whether the candidate node adjacency table is the same as the node adjacency table is determined.

The node adjacency table 502 is used as an initial node adjacency table. The MapReduce distributed operation is performed again to construct a label function F, so that each node can obtain the adjacency set of the node as its class label L to obtain the candidate node adjacency table, and whether the candidate node adjacency table is the same as the node adjacency table can be determined.

In a step S350, in response to the candidate node adjacency table being different from the node adjacency table, the candidate node adjacency table is used as the node adjacency table, and a candidate node adjacency table is regenerated.

If there is at least one adjacency set different in the candidate node adjacency table and in the node adjacency table, the initial node adjacency table is replaced by the candidate node adjacency table, and a candidate node adjacency table is regenerated again for a new iteration, while counting of an iteration determination flag is increased by 1. The iteration determination flag is reset to 0 at a beginning of each iteration. If the candidate node adjacency table is the same as the node adjacency table, the iteration determination flag remains unchanged. If the candidate node adjacency table is different from the node adjacency table, the counting of the iteration determination flag is increased by 1.

In a step S360, in response to the candidate node adjacency table being the same as the node adjacency table, the plurality of connected account sets are obtained according to the node adjacency table.

If the candidate node adjacency table is the same as the node adjacency table, that is, the iteration determination flag is equal to 0, then the iteration ends, the node adjacency table obtained in this iteration is used as a final node adjacency table, and the final node adjacency table is de-duplicated to obtain the plurality of connected account sets. As a result, a user connected group among which between users, one user provides order placement services to the other, is obtained.

As shown in FIG. 6, the step S340, in which a candidate node adjacency table is generated according to adjacency sets corresponding to different vertexes in the node adjacency table, includes following steps.

In a step S610, each account node in each of the adjacency sets is used as a vertex, and an adjacency set where each account node is located is used as the adjacency set corresponding to the vertex.

Account nodes in each of the adjacency sets are traversed, and each of the account nodes is used as a vertex, as shown in FIG. 7. The label function F is used to obtain an adjacency set of an account node from the node adjacency table 502, as the class label of the node. That is, a node class label set 701 is obtained by spreading each node adjacency set in the node adjacency table 502.

In a step S620, a candidate adjacency set is obtained by performing a union operation on the adjacency set corresponding to the same vertex, and the candidate node adjacency table is generated according to candidate adjacency sets corresponding to different vertexes.

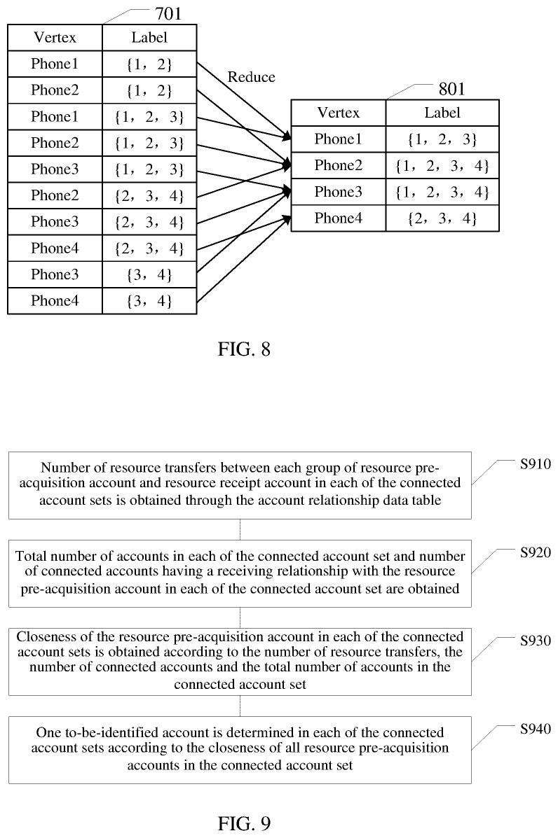

As shown in FIG. 8, vertexes and corresponding node class labels in the node class label set 701 are traversed, and class labels corresponding to the same vertex are merged to obtain the candidate adjacency set corresponding to this vertex. The union operation is performed for each vertex in the node class label set 701, so as to obtain candidate adjacency sets corresponding to each account node. The candidate node adjacency table 801 is generated according to the candidate adjacency sets.

After the plurality of connected account sets are obtained according to methods in FIGS. 3 to 8, the to-be-identified accounts that are most likely to be the target account are determined from each connected account set. In the identification of an account that provides order placement services, it is to determine an account with the highest probability of providing order placement services.

A Closeness Centrality Algorithm can be used to mine key nodes in a network. A reciprocal of an average value of a shortest distance from a node to all other reachable nodes is calculated, which can be used to measure the distance (i.e., closeness) from the node to other nodes.

In example embodiments of the present disclosure, the to-be-identified account in each connected account set can be determined through the Closeness Centrality Algorithm. Specific methods will be described as follows.

As shown in FIG. 9, the step S130, in which to-be-identified accounts in the plurality of connected account set are determined according to a connectivity relationship between accounts in each of the connected account sets, includes following steps.

In a step S910, number of resource transfers between each group of resource pre-acquisition account and resource receipt account in each of the connected account sets is obtained through the account relationship data table.

The number of resource transfers between the resource pre-acquisition account and the resource receipt account is the number of times of placing an order occurs between an ordering account and a receiving account. Based on the plurality of connected account sets obtained in above steps and the account relationship data table, a user relationship directed graph within the user connected group in each connected account set is constructed. If there is an out degree relationship, that is, a receiving relationship, between user a who places an order and user b who receives a commodity, then the number of times of placing an order occurs between user a who places an order and user b who receives a commodity is obtained.

In a step S920, total number of accounts in each of the connected account set and number of connected accounts having a receiving relationship with the resource pre-acquisition account in each of the connected account set are obtained.

In example embodiments of the present disclosure, the total number of accounts in a connected account set can be denoted by N, and the number of connected accounts having a receiving relationship with an account v can be denoted by R(v).

In a step S930, closeness of the resource pre-acquisition account in each of the connected account sets is obtained according to the number of resource transfers, the number of connected accounts and the total number of accounts in the connected account set.

A closeness weight of the resource pre-acquisition account can be obtained according to the number of resource transfers, that is, the closeness weight wₒᵤₜ is defined as a reciprocal of the number of times of placing an order.

The shortest distance from user v to user u is denoted as d(v, u):

$$d ( v , u ) = \{ \begin{matrix}{w}_{o u t} , if there exists an out - degree edge from v to u \\ 0 , if there is no out - degree edge from v to u\end{matrix}$$

The closeness centrality C(v) of user v can be expressed as:

$$C ( v ) = \frac{R ( v )}{N - 1} * \frac{R ( v )}{{\sum }_{u ∈ N} d ( v , u )} .$$

In a step S940, one to-be-identified account is determined in each of the connected account sets according to the closeness of all resource pre-acquisition accounts in the connected account set.

In example embodiments of the present disclosure, user i corresponding to a maximum Cₘₐₓ(i) of the closeness centrality in the connected account set can be used as the to-be-identified account in this set, that is, a suspected account that provides order placement services.

After the to-be-identified accounts in each set are obtained, a target account identification model can be trained according to sample accounts extracted from the to-be-identified accounts. The target account identification model can be used to identify all to-be-identified accounts, so as to obtain a target account, that is, an account that provides order placement services.

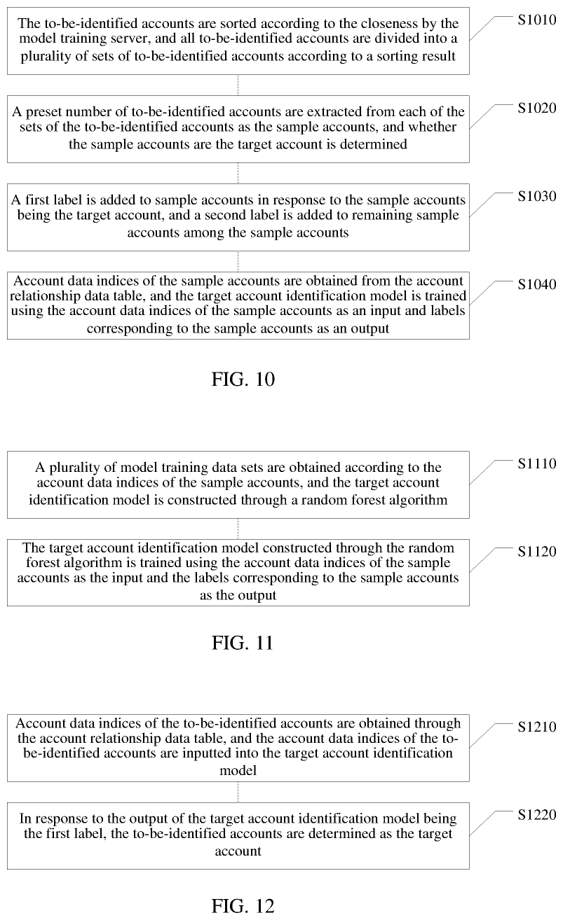

As shown in FIG. 10, the step S140, in which sample accounts are obtained by sampling from the to-be-identified accounts by the model training server, and a target account identification model is trained by using the sample accounts, includes following steps.

In a step S1010, the to-be-identified accounts are sorted according to the closeness by the model training server, and all to-be-identified accounts are divided into a plurality of sets of to-be-identified accounts according to a sorting result.

All to-be-identified accounts are sorted and segmented according to the closeness centrality by the model training server, and all to-be-identified accounts are divided into a plurality of sets of to-be-identified accounts.

In a step S1020, a preset number of to-be-identified accounts are extracted from each of the sets of the to-be-identified accounts as the sample accounts, and whether the sample accounts are the target account is determined.

A preset number of to-be-identified accounts are selected as the sample account from each of the sets of the to-be-identified accounts by stratified sampling, and whether these sample accounts are the target account is determined. In some embodiments, a specific method used for determination of the sample accounts is to make outbound calls to the users who place orders corresponding to these sample accounts, to determine whether the sample accounts are the account that provides order placement services. Other methods can also be used for determination of the sample accounts, which will not be specifically limited in example embodiments of the present disclosure.

In a step S1030, a first label is added to sample accounts in response to the sample accounts being the target account, and a second label is added to remaining sample accounts among the sample accounts.

After determination of the sample accounts, the first label is added to the target accounts, and the second label is added to the remaining sample accounts for model training.

In a step S1040, account data indices of the sample accounts are obtained from the account relationship data table, and the target account identification model is trained using the account data indices of the sample accounts as an input and labels corresponding to the sample accounts as an output.

The account data indices of all sample accounts are obtained based on the account relationship data table, including number of order addresses, number of coupons used, proportion of unregistered users, number of orders, number of commodity categories, and time of placing an order. These account data indices are associated, and a model dataset is constructed for further learning of the target account identification model.

As shown in FIG. 11, the step S1040, in which the target account identification model is trained using the account data indices of the sample accounts as an input and labels corresponding to the sample accounts as an output, includes following steps.

In a step S1110, a plurality of model training data sets are obtained according to the account data indices of the sample accounts, and the target account identification model is constructed through a random forest algorithm.

The random forest algorithm divides the data by randomly sampling with replacement N training samples from dataset samples, and by only considering M random indices characteristics each time. The random forest algorithm conducts a total of T rounds of sampling to obtain T training sets, and separately trains T decision trees. Each decision tree outputs a classification result of this decision tree, and votes for classification results of T decision trees to obtain a final classification result.

After the account data indices of the sample accounts are obtained, and in combination with the labels added to the sample accounts in step S1030, the data is divided into corresponding T model training datasets. Each model training dataset is used for the training of T decision trees.

In a step S1120, the target account identification model constructed through the random forest algorithm is trained using the account data indices of the sample accounts as the input and the labels corresponding to the sample accounts as the output.

Each decision tree in the model is trained independently, by using the account data indices of the sample accounts in each model training dataset as the input, and the labels corresponding to the sample accounts as the output. The final result is obtained by voting for the output of each decision tree, and is used as the output of the model to complete the training of the target account identification model.

As shown in FIG. 12, the step S150, in which whether the to-be-identified accounts are a target account is determined through the target account identification model, includes following steps.

In a step S1210, account data indices of the to-be-identified accounts are obtained through the account relationship data table, and the account data indices of the to-be-identified accounts are inputted into the target account identification model.

The account data indices of all to-be-identified accounts are obtained based on the account relationship data table, including number of order addresses, number of coupons used, proportion of unregistered users, number of orders, number of commodity categories, and time of placing an order, and the account data indices corresponding to each account are inputted into the trained target account identification model.

In a step S1220, in response to the output of the target account identification model being the first label, the to-be-identified accounts are determined as the target account.

After the account data indices of the to-be-identified account are inputted into the target account identification model, if the output of the model is the first label, the to-be-identified account is determined as the target account; if the output of the model is the second label, the to-be-identified account is determined as not the target account. The account data indices of all to-be-identified accounts are inputted into the target account identification model, respectively, and the target accounts can be identified according to the output of the model, that is, the accounts that provide order placement services can be identified.

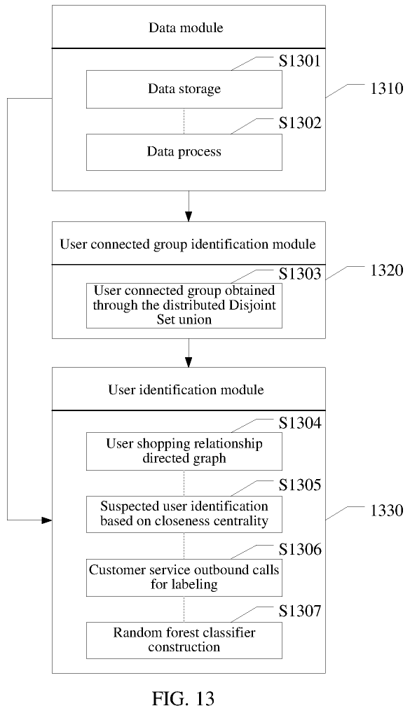

As shown in FIG. 13, a complete block diagram of a specific embodiment of the present disclosure is applied. The block diagram can include three modules, and the specific steps executed in each module are explained as follows.

1. The following steps can be executed in a data module 1310.

Step S1301, data storage.

Data such as an order number, a mobile phone number of a user who places the order, a mobile phone number of a user who receives a commodity are stored.

Step S1302, data process.

For example, number of times of placing an order is analyzed, order data that the mobile phone number of a user who places the order is the same as the mobile phone number of a user who receives a commodity is removed, and the user relationship data table such as a user who places the order, a user who receives a commodity, and the number of times of placing an order, is outputted.

2. The following steps can be executed in a user connected group identification module 1320.

Step S1303, a user connected group obtained through the distributed Disjoint Set union.

A plurality of connected account sets are obtained by classifying the accounts through the distributed Disjoint Set union method. Specific steps have been described in previous embodiments, which will not be repeated here.

3. The following steps can be executed in a user identification module 1330.

Step S1304, a user shopping relationship directed graph.

According to the plurality of connected account sets and account relationship data table, a user relationship directed graph within a user connected group in each of the connected account sets is constructed.

Step S1305, suspected user identification based on closeness centrality.

According to the closeness centrality, a user with the largest closeness centrality is selected from each of the connected account sets as the suspected user in the set.

Step S1306, customer service outbound calls for labeling.

Stratified sampling is conducted for all suspected users, and some sample accounts are selected to make outbound calls to the users for labeling.

Step S1307, a random forest classifier construction.

An account (that provides order placement services) identification model is constructed through the random forest algorithm, and the model is trained according to the account data indicators of the sample accounts with labels. The trained account identification model can used to identify an account that provides order placement services.

It should be noted that although steps of the method in embodiments of the present disclosure are described in the drawings in a specific order, this does not require or imply that these steps must be executed in that specific order, or that all steps shown must be executed to achieve a desired result. Additionally or optionally, some steps can be omitted, multiple steps can be combined into one step for execution, and/or one step can be decomposed into multiple steps for execution.

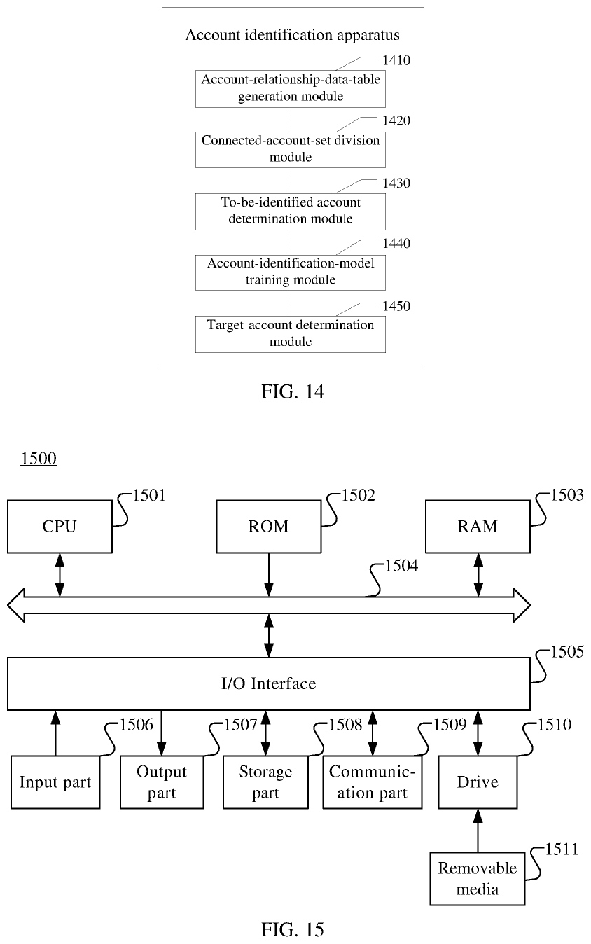

Furthermore, embodiments of the present disclosure also provide an account identification apparatus. As show in FIG. 14, the account identification apparatus may include an account-relationship-data-table generation module 1410, a connected-account-set division module 1420, a to-be-identified account determination module 1430, an account-identification-model training module 1440, and a target-account determination module 1450.

The account-relationship-data-table generation module 1410 may be configured to obtain by an account processing server, resource transfer records of which a resource pre-acquisition account is different from a resource receipt account, and generate an account relationship data table according to the resource transfer records.

The connected-account-set division module 1420 may be configured to divide the resource pre-acquisition account and the resource receipt account in the resource transfer records into a plurality of connected account sets according to the account relationship data table.

The to-be-identified account determination module 1430 may be configured to determine to-be-identified accounts in the plurality of connected account sets according to a connectivity relationship between accounts in each of the connected account sets, and send the to-be-identified accounts to a model training server.

The account-identification-model training module 1440 may be configured to obtain by the model training server, sample accounts by sampling from the to-be-identified accounts, and train a target account identification model by using the sample accounts.

The target-account determination module 1450 may be configured to determine whether the to-be-identified accounts are a target account through the target account identification model.

In some exemplary embodiments of the present disclosure, the account-relationship-data-table generation module 1410 may include an account determination unit, an account removing unit, and a data-table generation unit.

The account determination unit may be configured to obtain by the account processing server, account data of all resource transfer records, and determine whether the resource pre-acquisition account is the same as the resource receipt account in the account data of the resource transfer records.

The account removing unit may be configured to remove account data of resource transfer records in response to the resource pre-acquisition account being the same as the resource receipt account in the resource transfer records.

The data-table generation unit may be configured to put account data of resource transfer records into the account relationship data table in response to the resource pre-acquisition account being different from the resource receipt account in the resource transfer records.

In some exemplary embodiments of the present disclosure, the connected-account-set division module 1420 may include a node-relationship-pair generation unit, an account-node-table generation unit, a node-adjacency-table generation unit, a node-adjacency-table determination unit, a node-adjacency-table updating unit, and a connected-account-set determination unit.

The node-relationship-pair generation unit may be configured to obtain the resource pre-acquisition account and the resource receipt account in the resource transfer records from the account relationship data table, and generate a plurality of account node relationship pairs by using the resource pre-acquisition account and the resource receipt account in the resource transfer records as account nodes.

The account-node-table generation unit may be configured to obtain an account node table by using one account node in each of the account node relationship pairs as a vertex, and the other account node as a connection point corresponding to the vertex.

The node-adjacency-table generation unit may be configured to put a connection point corresponding to the same vertex in the account node table into the same set as an adjacency set corresponding to the vertex, and generating a node adjacency table according to the adjacency set.

The node-adjacency-table determination unit may be configured to generate a candidate node adjacency table according to the adjacency set in the node adjacency table, and determine whether the candidate node adjacency table is the same as the node adjacency table.

The node-adjacency-table updating unit may be configured to use, in response to the candidate node adjacency table being different from the node adjacency table, the candidate node adjacency table as the node adjacency table, and regenerate a candidate node adjacency table.

The connected-account-set determination unit may be configured to obtain, in response to the candidate node adjacency table being the same as the node adjacency table, the plurality of connected account sets according to the node adjacency table.

In some exemplary embodiments of the present disclosure, the node-adjacency-table determination unit may include an adjacency-set spreading unit and a candidate-adjacency-table generation unit.

The adjacency-set spreading unit may be configured to use each account node in the adjacency set as a vertex, and an adjacency set where each account node is located as the adjacency set corresponding to the vertex.

The candidate-adjacency-table generation unit may be configured to obtain a candidate adjacency set by performing a union operation on the adjacency set corresponding to the same vertex, and generate the candidate node adjacency table according to the candidate adjacency set.

In some exemplary embodiments of the present disclosure, the to-be-identified account determination module 1430 may include a closeness-weight determination unit, a closeness-parameter acquisition unit, a closeness calculation unit, and a to-be-identified account determination unit.

The closeness-weight determination unit may be configured to obtain number of resource transfers between each group of resource pre-acquisition accounts and resource receipt account in each of the connected account sets through the account relationship data table.

The closeness-parameter acquisition unit may be configured to obtain total number of accounts in each of the connected account sets and number of connected accounts in each of the connected account sets having a receiving relationship with the resource pre-acquisition account.

The closeness calculation unit may be configured to obtain, according to the number of resource transfers, the number of connected accounts and the total number of accounts, closeness of the resource pre-acquisition account in each of the connected account sets.

The to-be-identified account determination unit may be configured to determine, according to the closeness of the resource pre-acquisition account, one to-be-identified account in each of the connected account sets.

In some exemplary embodiments of the disclosure, the account-identification-model training module 1440 may include an account-set allocation unit, a target-account determination unit, an account-label adding unit, and an identification-model training unit.

The account-set allocation unit may be configured to sort, by the model training server, the to-be-identified accounts according to the closeness, and divide all to-be-identified accounts into a plurality of sets of the to-be-identified accounts according to a sorting result.

The target-account determination unit may be configured to extract a preset number of to-be-identified accounts from each of the sets of the to-be-identified accounts as the sample accounts, and determine whether the sample accounts are the target account.

The account-label adding unit may be configured to add a first label to sample accounts in response to the sample accounts being the target account, and add a second label to remaining sample accounts among the sample accounts.

The identification-model training unit may be configured to obtain account data indices of the sample accounts from the account relationship data table, and train the target account identification model using the account data indices of the sample accounts as an input and labels corresponding to the sample accounts as an output.

In some exemplary embodiments of the present disclosure, the identification-model training unit may include an identification-model construction unit and a multi-model training unit.

The identification-model construction unit may be configured to obtain a plurality of model training data sets according to the account data indices of the sample accounts, and construct the target account identification model through a random forest algorithm.

The multi-model training unit may be configured to train the target account identification model constructed through the random forest algorithm using the account data indices of the sample accounts as the input and the labels corresponding to the sample accounts as the output.

In some exemplary embodiments of the present disclosure, the target-account determination module 1450 may include an account data input unit and a target account identification unit.

The account data input unit may be configured to obtain account data indices of the to-be-identified accounts through the account relationship data table, and input the account data indices of the to-be-identified accounts into the target account identification model.

The target account identification unit may be configured to determine the to-be-identified accounts as the target account in response to the output of the target account identification model being the first label.

Specific details of each module/unit in above account identification apparatus have been described in detail in corresponding method embodiments, which will not be repeated here.

FIG. 15 shows a schematic structural diagram of a computer system of an electronic device suitable for implementing an exemplary embodiment of the present disclosure.

It should be noted that the computer system 1500 of the electronic device shown in FIG. 15 is only an example and should not impose any restrictions on the functions and use scope of embodiments of the present disclosure.

As shown in FIG. 15, the computer system 1500 includes a central processing unit (CPU) 1501, which can perform various appropriate actions and processes according to a program stored in a read-only memory (ROM) 1502 or a program loaded from a storage part 1508 into a random access memory (RAM) 1503. RAM 1503 also stores various programs and data required for system operation. CPU 1501, ROM 1502 and RAM 1503 are connected to each other through bus 1504. An input/output (I/O) interface 1505 is also connected to bus 1504.

The following components are connected to the I/O interface 1505: an input part 1506 including such as keyboard, mouse; an output part 1507 including such as a cathode ray tube (CRT), a liquid crystal display (LCD), and a loudspeaker; a storage part 1508 including such as a hard disk; and a communication part 1509 including a network interface card such as a LAN card, a modem, and the like. The communication part 1509 performs communication processing via a network such as the Internet. A drive 1510 is also connected to the I/O interface 1505 as required. A removable media 1511, such as magnetic disks, optical disks, magneto-optical disks, and semiconductor memories, are installed on the drive 1510 as required, so that computer programs read from the drive 1510 can be installed into the storage part 1508 as required.

According to embodiments of the present disclosure, the process described below with reference to a flowchart can be implemented as a computer software program. For example, embodiments of the present disclosure include a computer program product, which includes a computer program carried on a computer-readable medium, and the computer program includes program codes for executing a method shown in a flowchart. In such embodiments, the computer program can be downloaded and installed from the network through the communication part 1509, and/or installed from the removable media 1511. When the computer program is executed by the central processing unit (CPU) 1501, various functions defined in systems of the present disclosure are executed.

It should be noted that the computer-readable medium shown in the present disclosure can be a computer-readable signal medium, a computer-readable storage medium, or any combination of the two. The computer-readable storage medium may be, for example, but not limited to, an electrical, magnetic, optical, electromagnetic, infrared, or semiconductor system, apparatus or device, or a combination of any of the above. More specific examples (non-exhaustive list) of readable storage media include, electrical connections with one or more wires, portable disks, hard disks, random access memory (RAM), read only memory (ROM), erasable programmable read only memory (EPROM or flash), optical fiber, portable compact disk read only memory (CD-ROM), optical storage devices, magnetic storage devices, or any suitable combination of the above. In the present disclosure, a computer-readable storage medium may be any tangible medium containing or storing a program, which may be used by or in combination with an instruction execution system, apparatus, or device. In the present disclosure, a computer-readable signal medium may include data signals transmitted in baseband or as part of a carrier wave, in which computer-readable program code is carried. Such transmitted data signals may take various forms, including but not limited to electromagnetic signals, optical signals or any suitable combination of the above. A computer-readable signal medium may also be any computer-readable medium other than a computer-readable storage medium, which may send, propagate, or transmit programs for use by or in combination with an instruction execution system, apparatus, or device. The program code contained in the computer readable medium can be transmitted in any suitable medium, including but not limited to wireless, wired, optical cable, RF, etc., or any suitable combination of the above.

The flowchart and block diagram in the accompanying drawings illustrate possible architectures, functions and operations of the systems, methods and computer program products according to various embodiments of the present disclosure. In this regard, each block in a flowchart or block diagram may represent a module, program segment, or part of a code that contains one or more executable instructions for implementing a specified logical function. It should also be noted that in some alternative implementations, the functions marked in the block may also occur in a different order from those marked in the drawings. For example, two consecutive boxes can actually be executed basically in parallel, or they can sometimes be executed in reverse order, depending on the function involved. It should also be noted that each block in the block diagram or flow chart, and the combination of the blocks in the block diagram or flow chart, can be implemented with a dedicated hardware based system that performs a specified function or operation, or can be implemented with a combination of dedicated hardware and computer instructions.

On the other hand, the application also provides a computer-readable medium, which can be included in the electronic devices described in the above embodiments; It can also exist independently without being assembled into the electronic device. The computer-readable medium carries one or more programs. When the one or more programs are executed by one electronic device, the electronic device realizes the method described in the following embodiment.

It should be noted that although several modules of the device for action execution are mentioned in the above detailed description, this division is not mandatory. In fact, according to the embodiment of the present disclosure, the features and functions of two or more modules described above can be embodied in one module. On the contrary, the features and functions of a module described above can be further divided into multiple modules for materialization.

After considering the specification and practicing the invention disclosed herein, those skilled in the art will easily think of other embodiments of the disclosure. The application is intended to cover any variant, use or adaptive change of the disclosure, which follows the general principles of the disclosure and includes the common general knowledge or frequently used technical means in the technical field not disclosed in the disclosure.

It should be understood that the present disclosure is not limited to the precise structure already described above and shown in the drawings, and various modifications and changes can be made without departing from its scope. The scope of this disclosure is limited only by the appended claims.

1. An account identification method, comprising:
obtaining, by an account processing server, resource transfer records of which a resource pre-acquisition account is different from a resource receipt account, and generating an account relationship data table according to the resource transfer records;
dividing the resource pre-acquisition account and the resource receipt account in the resource transfer records into a plurality of connected account sets according to the account relationship data table;
determining to-be-identified accounts in the plurality of connected account sets according to a connectivity relationship between accounts in each of the connected account sets, and sending the to-be-identified accounts to a model training server;
obtaining, by the model training server, sample accounts by sampling from the to-be-identified accounts, and training a target account identification model by using the sample accounts; and
determining whether the to-be-identified accounts are a target account through the target account identification model.

2. The account identification method according to claim 1, wherein obtaining, by an account processing server, resource transfer records of which a resource pre-acquisition account is different from a resource receipt account, and generating an account relationship data table according to the resource transfer records, comprising:
obtaining, by the account processing server, account data of the resource transfer records, and determining whether the resource pre-acquisition account is the same as the resource receipt account in the account data of the resource transfer records;
removing account data of resource transfer records in response to the resource pre-acquisition account being the same as the resource receipt account in the resource transfer records; and
putting account data of resource transfer records into the account relationship data table in response to the resource pre-acquisition account being different from the resource receipt account in the resource transfer records.

3. The account identification method according to claim 1, wherein dividing the resource pre-acquisition account and the resource receipt account in the resource transfer records into a plurality of connected account sets according to the account relationship data table, comprising:
obtaining the resource pre-acquisition account and the resource receipt account in the resource transfer records from the account relationship data table, and generating a plurality of account node relationship pairs by using the resource pre-acquisition account and the resource receipt account in the resource transfer records as account nodes;
obtaining an account node table by using one account node in each of the account node relationship pairs as a vertex, and the other account node as a connection point corresponding to the vertex;
putting a connection point corresponding to the same vertex in the account node table into the same set as an adjacency set corresponding to the vertex, and generating a node adjacency table according to adjacency sets corresponding to different vertexes;
generating a candidate node adjacency table according to the adjacency sets in the node adjacency table, and determining whether the candidate node adjacency table is the same as the node adjacency table;
using, in response to the candidate node adjacency table being different from the node adjacency table, the candidate node adjacency table as the node adjacency table, and regenerating a candidate node adjacency table; and
obtaining, in response to the candidate node adjacency table being the same as the node adjacency table, the plurality of connected account sets according to the node adjacency table.

4. The account identification method according to claim 3, wherein generating a candidate node adjacency table according to adjacency sets corresponding to different vertexes in the node adjacency table, comprising:
using each account node in each of the adjacency sets as a vertex, and an adjacency set where each account node is located as the adjacency set corresponding to the vertex; and
obtaining a candidate adjacency set by performing a union operation on the adjacency set corresponding to the same vertex, and generating the candidate node adjacency table according to candidate adjacency sets corresponding to different vertexes.

5. The account identification method according to claim 1, wherein determining to-be-identified accounts in the plurality of connected account sets according to a connectivity relationship between accounts in each of the connected account sets, comprising:
obtaining number of resource transfers between each group of resource pre-acquisition account and resource receipt account in each of the connected account sets through the account relationship data table;
obtaining total number of accounts in each of the connected account sets and number of connected accounts having a receiving relationship with the resource pre-acquisition account in each of the connected account sets;
obtaining, according to the number of resource transfers, the number of connected accounts and the total number of accounts, closeness of the resource pre-acquisition account in each of the connected account sets; and
determining, according to the closeness of the resource pre-acquisition account, one to-be-identified account in each of the connected account sets.

6. The account identification method according to claim 5, wherein obtaining, by the model training server, sample accounts by sampling from the to-be-identified accounts, and training a target account identification model by using the sample accounts, comprising:
sorting, by the model training server, the to-be-identified accounts according to the closeness, and dividing the to-be-identified accounts into a plurality of sets of the to-be-identified accounts according to a sorting result;
extracting a preset number of to-be-identified accounts from each of the sets of the to-be-identified accounts as the sample accounts, and determining whether the sample accounts are the target account;
adding a first label to sample accounts in response to the sample accounts being the target account, and adding a second label to remaining sample accounts among the sample accounts; and
obtaining account data indices of the sample accounts from the account relationship data table, and training the target account identification model using the account data indices of the sample accounts as an input and labels corresponding to the sample accounts as an output.

7. The account identification method according to claim 6, wherein training the target account identification model using the account data indices of the sample accounts as an input and labels corresponding to the sample accounts as an output, comprising:
obtaining a plurality of model training data sets according to the account data indices of the sample accounts, and constructing the target account identification model through a random forest algorithm; and
training the target account identification model constructed through the random forest algorithm using the account data indices of the sample accounts as the input and the labels corresponding to the sample accounts as the output.

8. The account identification method according to claim 6, wherein determining whether the to-be-identified accounts are a target account through the target account identification model, comprising:
obtaining account data indices of the to-be-identified accounts through the account relationship data table, and inputting the account data indices of the to-be-identified accounts into the target account identification model; and
determining the to-be-identified accounts as the target account in response to the output of the target account identification model being the first label.

9. (canceled)

10. An electronic device, comprising:
a processor; and
a memory for storing one or more programs, which when executed by the processor, cause the processor to be configured to:
obtain, by an account processing server, resource transfer records of which a resource pre-acquisition account is different from a resource receipt account, and generate an account relationship data table according to the resource transfer records;
divide the resource pre-acquisition account and the resource receipt account in the resource transfer records into a plurality of connected account sets according to the account relationship data table;
determine to-be-identified accounts in the plurality of connected account sets according to a connectivity relationship between accounts in each of the connected account sets, and send the to-be-identified accounts to a model training server;
obtain, by the model training server, sample accounts by sampling from the to-be-identified accounts, and train a target account identification model by using the sample accounts; and
determine whether the to-be-identified accounts are a target account through the target account identification model.

11. (canceled)

12. The electronic device according to claim 10, wherein the processor is further configured to:
obtain, by the account processing server, account data of the resource transfer records, and determine whether the resource pre-acquisition account is the same as the resource receipt account in the account data of the resource transfer records;
remove account data of resource transfer records in response to the resource pre-acquisition account being the same as the resource receipt account in the resource transfer records; and
put account data of resource transfer records into the account relationship data table in response to the resource pre-acquisition account being different from the resource receipt account in the resource transfer records.

13. The electronic device according to claim 10, wherein the processor is further configured to:
obtain the resource pre-acquisition account and the resource receipt account in the resource transfer records from the account relationship data table, and generate a plurality of account node relationship pairs by using the resource pre-acquisition account and the resource receipt account in the resource transfer records as account nodes;
obtain an account node table by using one account node in each of the account node relationship pairs as a vertex, and the other account node as a connection point corresponding to the vertex;
put a connection point corresponding to the same vertex in the account node table into the same set as an adjacency set corresponding to the vertex, and generate a node adjacency table according to adjacency sets corresponding to different vertexes;
generate a candidate node adjacency table according to the adjacency sets in the node adjacency table, and determine whether the candidate node adjacency table is the same as the node adjacency table;
use, in response to the candidate node adjacency table being different from the node adjacency table, the candidate node adjacency table as the node adjacency table, and regenerate a candidate node adjacency table; and
obtain, in response to the candidate node adjacency table being the same as the node adjacency table, the plurality of connected account sets according to the node adjacency table.

14. The electronic device according to claim 13, wherein the processor is further configured to:
use each account node in each of the adjacency sets as a vertex, and an adjacency set where each account node is located as the adjacency set corresponding to the vertex; and
obtain a candidate adjacency set by performing a union operation on the adjacency set corresponding to the same vertex, and generate the candidate node adjacency table according to candidate adjacency sets corresponding to different vertexes.

15. The electronic device according to claim 10, wherein the processor is further configured to:
obtain number of resource transfers between each group of resource pre-acquisition account and resource receipt account in each of the connected account sets through the account relationship data table;
obtain total number of accounts in each of the connected account sets and number of connected accounts having a receiving relationship with the resource pre-acquisition account in each of the connected account sets;
obtain, according to the number of resource transfers, the number of connected accounts and the total number of accounts, closeness of the resource pre-acquisition account in each of the connected account sets; and
determine, according to the closeness of the resource pre-acquisition account, one to-be-identified account in each of the connected account sets.

16. The electronic device according to claim 15, wherein the processor is further configured to:
sort, by the model training server, the to-be-identified accounts according to the closeness, and divide the to-be-identified accounts into a plurality of sets of the to-be-identified accounts according to a sorting result;
extract a preset number of to-be-identified accounts from each of the sets of the to-be-identified accounts as the sample accounts, and determine whether the sample accounts are the target account;
add a first label to sample accounts in response to the sample accounts being the target account, and add a second label to remaining sample accounts among the sample accounts; and
obtain account data indices of the sample accounts from the account relationship data table, and train the target account identification model using the account data indices of the sample accounts as an input and labels corresponding to the sample accounts as an output.

17. The electronic device according to claim 16, wherein the processor is further configured to:
obtain a plurality of model training data sets according to the account data indices of the sample accounts, and construct the target account identification model through a random forest algorithm; and
train the target account identification model constructed through the random forest algorithm using the account data indices of the sample accounts as the input and the labels corresponding to the sample accounts as the output.

18. The electronic device according to claim 16, wherein the processor is further configured to:
obtain account data indices of the to-be-identified accounts through the account relationship data table, and input the account data indices of the to-be-identified accounts into the target account identification model; and
determine the to-be-identified accounts as the target account in response to the output of the target account identification model being the first label.
